(19) United States
(12) Patent Application Publication
(10) Pub. No.: US 2010/0160681 A1
(43) Pub. Date: Jun. 24, 2010

(54) Chiral phosphoramides, chiral N-phosphonimines and methods for forming the same

(75) Inventors: Xiangzhen Sun, Suzhou City (CN); Li Guigen, Lubbock, TX (US)

Correspondence Address: EDWARDS ANGELL PALMER & DODGE LLP, P.O. BOX 55874, BOSTON, MA, 02205, US

(73) Assignee: NOWA Pharmaceuticals, Co., Ltd., Suzhou City (CN)

(21) Appl. No.: 12/653,682

(22) Filed: Dec. 16, 2009

Related U.S. Application Data
(63) Continuation of application No. PCT/CN2008/071419, filed on Jun. 24, 2008.
(60) Provisional application No. 60/937,213, filed on Jun. 25, 2007.

(51) Int. Cl. C07F 9/6506

(52) U.S. Cl. 564/13

(57) ABSTRACT

This application relates to the design and synthesis of new chiral imines reagents which can be utilized for the synthesis of chiral drugs and their precursors. It describes the design of the free NH2-group-attached chiral phosphoramides, a chiral N-phosphonimines and the methods for forming the same. The free NH2-group-attached chiral phosphoramides, having the structure of formula (I):

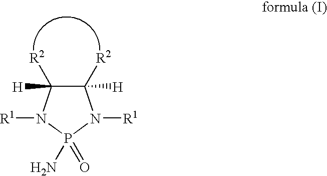

wherein R1 and R2 are independently any organic groups. The synthesis of N-phosphoramides was performed starting from chiral 1,2-diamines via the following steps: N,N′-dialkylation consisting of aldehyde condensation and reduction, cyclization with phosphoryl halide, substitution of halide with azide anion and hydrogenation of azides. The N-phosphonyl imines are synthesized by condensation of N-phosphoramides with aldehydes. Quantitative yield was obtained for each of the four steps without special purification. All precursors were obtained as white solids. It should be addressed that after each application reaction of N-phosphonyl imines, N,N′-dialkyl vicinal diamine auxiliaries can be recovered quantitatively with one-time extraction using n-butanol and re-used.

### RELATED APPLICATIONS

This present invention is a continuation patent application that claims priority to PCT patent application number PCT/CN2008/071419, filed Jun. 24, 2008, which claims the benefit of U.S. Application 60/937,213, filed on Jun. 25, 2007, the entirety of which are herein incorporated by reference.

### FIELDS OF THE INVENTION

The invention relates to the design and synthesis of new chiral imines reagents which can be utilized for the synthesis of chiral drugs and their precursors. In particular, it relates to free NH2-group-attached chiral phosphoramides, chiral N-phosphonimines and the methods for forming the same. Chiral N-phosphonimines (or called N-phosphonyl imines) are prepared using new chiral phosphoramides.

### TECHNICAL BACKGROUND

The chiral imine chemistry has been one of the most active topics in asymmetric synthesis because the drug development and discovery heavily depend on the amine functionality (F. A. Davis, P. Zhou, B. C. Chen, Chem. Soc. Rev. 1998, 27, 13-18). In the past several decades, this field has been dominated by N-sulfinyl imine (or sulfinimine) chemistry which was pioneered by Davis (F. A. Davis, B. Yang, J. Am. Chem. Soc. 2006, 127, 8938-8407; F. A. Davis, R. E. Reddy, J. M. Szewczyk, G. V. Reddy, P. S. Potonovo, H. Zhang, D. T. Reddy, P. Zhou, P. Carroll, J. Org. Chem. 1997, 62, 2555-2563), Ellman (D. A. Cogan, G. C. Liu, K. J. Kim, B. J. Backes, J. A. Ellman J. Am. Chem. Soc. 1998, 120, 8011-8019; D. A. Cogan, J. A. Ellman, J. Am. Chem. Soc. 1999, 121, 268-269; D. J. Weix, Y. L. Shi, J. A. Ellman, J. Am. Chem. Soc. 2005, 127, 1092-1093) and several others (X. Han, D. Krishnamurthy, P. Grover, Q. K. Fang, C. H. Senanayake, J. Am. Chem. Soc. 2002, 124, 7880-7881; J. G. Ruano, I. Fernandez, M. del P. Catalina, A. A. Cruz, Tetrahedron Asymm., 1996, 7, 3407-3414; X. W. Sun, M. H. Xu, G. Q. Lin, Org. Lett. 2006, 8, 4979-4982; C. H. Zhao, L. Liu, D. Wang, Y. J. Chen, Eur. J. Org. Chem. 2006, 2977-2986; D. H. Hua, S. W. Miao, J. S. Chen, S. Iguchi, J. Org. Chem. 1991, 56, 4-6) (FIGS. 1, A & B). Very recently, it has been addressed that asymmetric nucleophilic additions of organometallic reagents to C═N bonds of chiral sulfinimines represents “the most direct and reliable method for the asymmetric construction of diverse amine derivatives having a nitrogen attached to a stereogenic center” (F. A. Davis, J. Org. Chem. 2006, 71, 8993-9003)). In a recent effort on the development of new chiral nitrogen sources to render asymmetric aminohalogenation and diamination reactions (G. Li, H.-X. Wei, S. H. Kim, M. D. Carducci, Angew. Chem. Int. Ed. Engl. 2001, 40, 4277-4280; H.-X. Wei, S. H. Kim, G. Li, J. Org. Chem. 2002, 67, 4777-4781; D. Chen, C. Timmons, H.-X. Wei, G. Li, J. Org. Chem. 2003, 68, 5742-5745; C. Timmons, D. Chen, X. Xu, G. Li, Eur. J. Org. Chem. 2003, 3850-3854; W. Pei, H.-X. Wei, D. Chen, A. D. Headley, G. Li, J. Org. Chem. 2003, 68, 8404-8408; J.-L. Han, S.-J. Zhi, L.-Y. Wang, Y. Pan, G. Li, Eur. J. Org. Chem. 2007, 1332-1337; J. Liu, Y.-N. Wang, G. Li, Eur. J. Org. Chem. 2006, 3112-3115; Q. Li, M. Shi, C. Timmons, G. Li, Org. Lett. 2006, 8, 625-628; X. Xu, S. R. S. S. Kotti, J. Liu,; J. F. Cannon, A. D. Headley, G. Li, Org. Lett. 2004, 6, 4881-4884), it was found that one of these nitrogen sources, the free NH₂ group-attached phosphoramide (FIG. 1, C), can be readily converted into chiral N-phosphonyl imines (FIG. 1, D) to serve as electrophiles for asymmetric nucleophilic additions by organometallic reagents.

Even though a great progress has been made on N-sulfinyl imine chemistry, there still exist some limitations during the use of N-sulfinyl imines for asymmetric synthesis. In addition to the shortcomings described in literature, the N-sulfinyl functionality is sensitive to oxidative conditions, which makes some further transformations inconvenient. The deprotection of N-sulfinyl group is performed by treating with BrØnsted-Lowry acids, which destroys the chiral functionality and makes the recovery of chiral auxiliary impossible; Or, possible racemization can occur on sulfur center if other methods are used. This functionality cannot tolerate strong Lewis acids well (G. Li, H.-X. Wei, B. Whittlesey, N. N. Batrice, J. Org. Chem. 1999, 64, 1061-1064; H.-X. Wei, J. D. Hook, K. A. Fitzgerald, G. Li, Tetrahedron: Asymmetry 1999, 10, 661-665). In addition, the preparation of the N-sulfinyl imines requires either expensive starting materials or the use of a disulfide which is very harmful to environment (toxic and smelling). Therefore, it is necessary to develop new chiral imines to overcome shortcomings of N-sulfinyl imines.

### SUMMARY OF THE INVENTION

The purpose of the application is to provide free NH₂ group-attached chiral phosphoramides and corresponding chiral N-phosphonyl imines as well as the methods for forming the same, so as to overcome the above shortcomings of N-sulfinyl imines.

The application provides the technical solution in following aspects:

Free NH2-group-attached chiral phosphoramides, having the structure of formula (I):

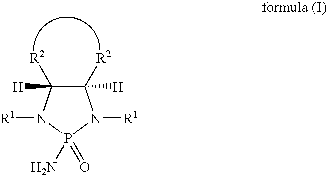

wherein R1 and R2 are independently any organic groups.

The free NH2-group-attached chiral phosphoramides, wherein R1 is a C1-C20 alkyls, such as i-Pr, Me, Et, Pr, 2-Bu; Aryl; CH2-Aryl (e.g., Aryl=Ph, 1-Naph, 2-Naph, etc.); and Ts, Bs, Ms and C1-C20-R—SO2-, Ar—SO2-; R2 is an Aryl, Alkyl; two alkyl R2 groups can be connected as cycloalkanes, i.e., diamine precursors can be 1,2-diaminocyclohexane and 1,2-diaminocyclopentane.

The compounds of formula (I) can be racemic compounds or each of the two individual enantiomers, or combination thereof.

The free NH2-group-attached chiral phosphoramides, having one of the structures of formula (II):

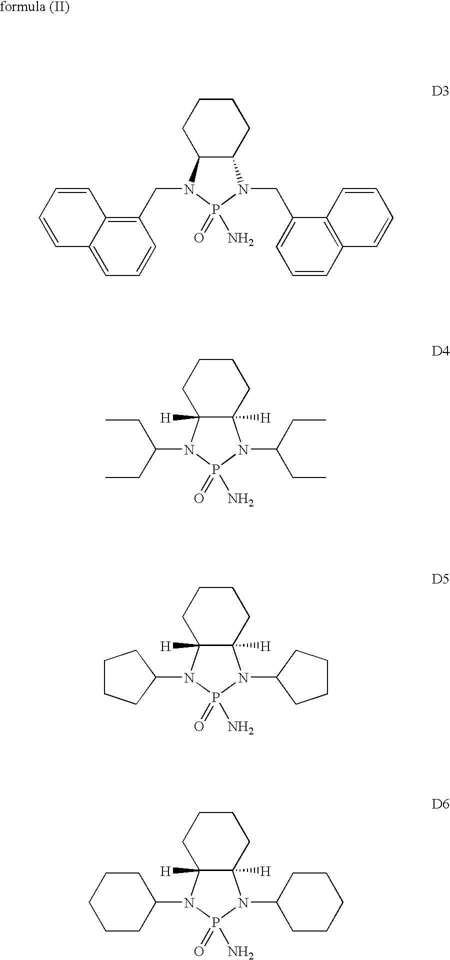

Chiral N-phosphonimines, having the structure of formula (III)

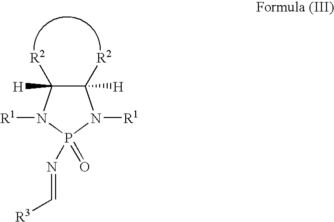

wherein R1, R2 and R3 are independently any organic groups.

The chiral N-phosphonimine, wherein R1 is a C1-C20 alkyls, such as i-Pr, Me, Et, Pr, 2-Bu; Aryl; CH2-Aryl (e.g., Aryl=Ph, 1-Naph, 2-Naph, etc.); and Ts, Bs, Ms and C1-C20-R—SO2-, Ar—SO2-; R2 is an Aryl, Alkyl in which two allyl R2 groups can be connected as cycloalkanes, i.e., diamine precursors can be 1,2-diaminocyclohexane and 1,2-diaminocyclopentane; R3 is an Aryl, Alkyl group.

The chiral N-phosphonimines, having one of the structures of formula (IV):

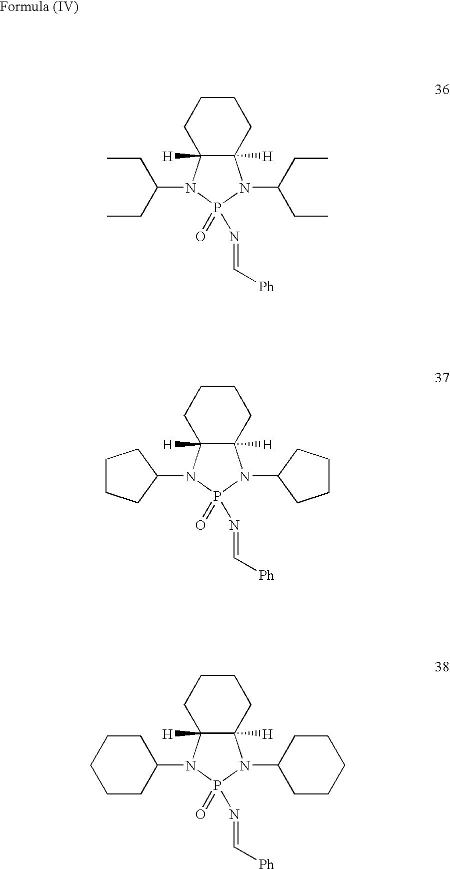

A method of forming the free NH2-group-attached chiral phosphoramides of formula (I), comprising: a) providing phosphoramides, and 2) synthesizing chiral N-phosphonimines from free NH2-group-attached chiral phosphoramides.

The method comprises the steps of:
A. Synthesis of N,N′-di-primary alkyl-1,2-diaminocyclohexane;
B. Synthesis of N,N′-di secondary alkyl-1,2-diaminocyclohexane.

The method comprises the reaction for synthesis of N,N′-di-primary alkyl-N-phosphoramides of formula (V):

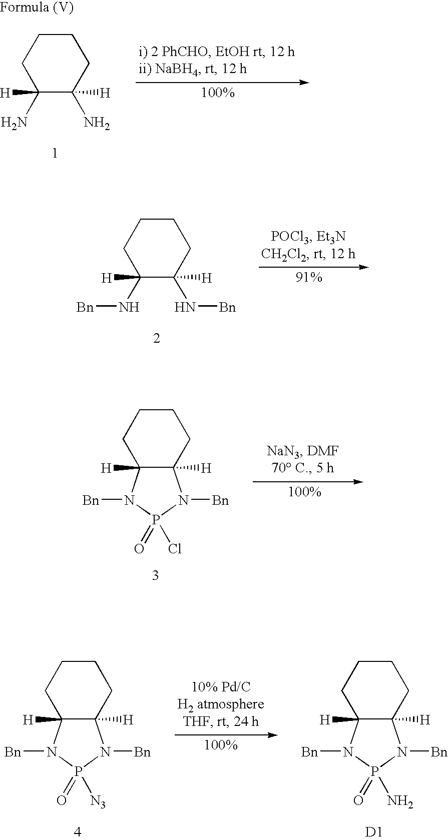

The method comprises the reaction for synthesis of N,N′-di-secondary alkyl-N-phosphoramides of formula (VI):

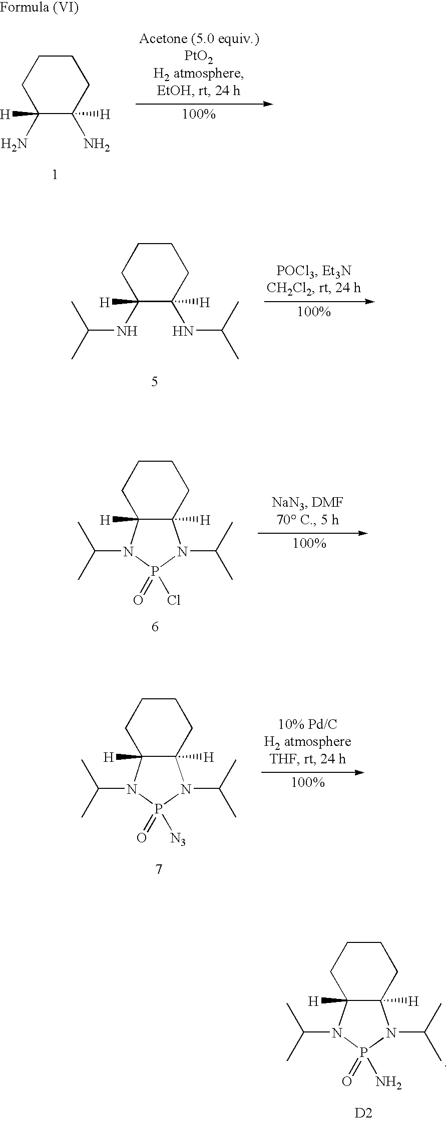

The use of the free NH2-group-attached chiral phosphoramides of formula (I) in preparing of chiral N-phosphonimines.

A method of forming the chiral N-phosphonyl imines of formula (III), comprise the steps of:
A. Synthesis of N,N′-di-primary alkyl-N-phosphonyl imines;
B. Synthesis of N,N′-di-secondary alkyl-N-phosphonyl imines.

The method comprises the reaction for synthesis of synthesis of chiral N-phosphonyl imines of formula (VII):

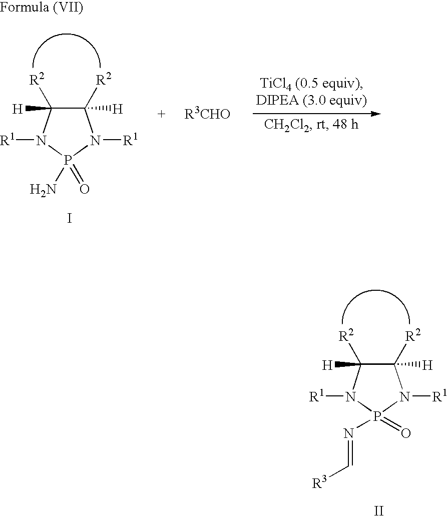

The advantages of the application are: these imines can be utilized for many asymmetric reactions, such as asymmetric aza-Darzens reaction to give aziridines (see, e.g., F. A. Davis, H. Liu, P. Zhou, T. Fang, G. V. Reddy, Y. Zhang, J. Org. Chem. 1999, 64, 7559-7567; J. B. Sweeney, A. A. Cantrill, A. B. McLaren, S. Thobhani, Tetrahedron 2006, 62, 3681-3693; N. Giubellina, S. Mangelinckx, K. W. Tornroos, N. De Kimpe, J. Org. Chem. 2006, 71, 5881-5887; J.-Y. Wang, D.-X. Wang, Q.-Y. Zheng, Z.-T. Huang, M.-X. Wang, J. Org. Chem. 2007, 72, 2040-2045), asymmetric aza-Henry reaction (see, e.g., B. Westermann, Angew. Chem. 2003, 115, 161-163; Angew. Chem. Int. Ed. Engl. 2003, 42, 151-153; M. P. Lalonde, Y. Chen, E. N. Jacobsen, Angew. Chem. Int. Ed. Engl. 2006, 45, 6366-6370; K. R. Knudsen, T. Risgaad, N. Nishiwaki, K. V. Gothelf, K. A. Jorgensen, J. Am. Chem. Soc. 2001, 123, 5843-5844; C. Palomo, M. Oiarbide, R. Halder, A. Laso, R. Lopez, Angew. Chem. Int. Ed. Engl. 2006, 45, 117-120) and other reactions.

### BRIEF DESCRIPTION OF THE DRAWINGS

FIG. 1 shows the general structures of chiral N-sulfinyl, N-phosphonyl imines and phosphoramides.

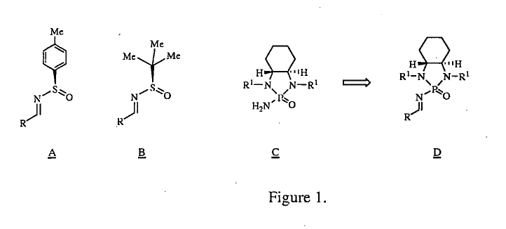

### DETAILED DESCRIPTION OF THE INVENTION

The present invention describes free NH₂ group-attached chiral phosphoramides and methods of forming the same. These compounds are important and very useful synthetic building blocks for drugs and their precursors.

### Free NH₂ Group-Attached Chiral Phosphoramides

In some embodiments, the present invention provides free NH₂ group-attached chiral phosphoramides C. In some embodiment, the free NH₂ group-attached chiral phosphoramides can be any of the compounds shown in formula (I), wherein R, R¹ to R³ are independently any alkyl and aryl groups, and R¹ can also be any sulfonyl groups. In some embodiments, the present invention provides compounds as formula (I); wherein R¹ is a C1-C₂₀ alkyl such as i-Pr, Me, Et, Pr, 2-Bu; Aryl; CH₂-Aryl (e.g., Aryl=Ph, 1-Naph, 2-Naph, etc.); and Ts, Bs, Ms and C1-C₂₀—R—SO₂—, Ar—SO₂—. R² is a Aryl, Alkyl; two alkyl R2 groups can be connected as cycloalkanes, i.e., diamine precursors can be 1,2-diaminocyclohexane and 1,2-diaminocyclopentane.

The compounds shown in formula (I) can be racemic compounds or each of the two individual enantiomers, or combination thereof.

### Chiral N-Phosphonyl Imines

In some embodiments, the present invention provides new chiral N-phosphonyl imines D. In some embodiment, chiral N-phosphonyl imines D are any of the compounds shown in formula (III), wherein R, R¹ to R³ are independently any alkyl and aryl groups, and R¹ can also be any sulfonyl groups. In some embodiments, the present invention provides compounds as shown in FIG. 2, wherein R¹ is a C₁-C₂₀ alkyl such as i-Pr, Me, Et, Pr, 2-Bu; Aryl; CH₂-Aryl (e.g., Aryl=Ph, 1-Naph, 2-Naph, etc)); and Ts, Bs, Ms and C₁-C₂₀—R—SO₂—, Ar—SO₂—. R² is a Aryl, Alkyl; two alkyl R² groups can be connected as cycloalkanes, i.e., diamine precursors can be 1,2-diaminocyclohexane and 1,2-diaminocyclopentane. R³ can be any aryl and alkyl groups.

The compounds shown in formula (III) can be racemic compounds or each of the two individual enantiomers, or combination thereof.

### Methods of Making

In some embodiments, the present invention also provides methods of making of free NH₂ group-attached chiral phosphoramides. The methods include: a) providing approach to phosphoramides, and b) synthesizing a chiral N-phosphonyl imines from free NH₂ group-attached chiral phosphoramides.

In some embodiments, the method provides the synthesis of chiral N-phosphonyl imines.

### Example

### Synthesis of the Free NH₂ Group-Attached Phosphoramides

Four steps are needed for the synthesis of phosphoramides. These steps can also be handled in situ. The synthesis of phosphoramides was performed starting from protected 1,2-diamines or aminoalcohols according to a similar procedure for the synthesis of N-alkyl phosphoramides (S. E. Denmark, Nature, 2006, 443, 40-41; S. E. Denmark, R. A. Stavenger, J. Am. Chem. Soc. 2000, 122, 8837-8847; S. E. Denmark, Y.-P. Su, Y. Nishigaichi, D. M. Coe, K. T. Wong, S. B. D. Winter, J. Y. Choi, J. Org. Chem. 1999, 64, 1958-1967).

### A. Synthesis of N,N′-di-primary alkyl-1,2-diaminocyclohexane (Formula (V))

### 1) Synthesis of (1R,2R)—N,N′-dibenzyl-1,2-diaminocyclohexane 2

Into a 250 mL three-neck round bottom flask equipped with a calcium chloride drying tube were taken (1R,2R)-(−)-1,2-Diaminocyclohexane 1 (2.283 g, 20.0 mmol) and 40.0 mL of ethanol. Benzaldehyde (4.062 mL, 40.0 mmol) was added drop wise to this solution at rt with the help of a pressure-equalizing funnel. After stirring 24 h at rt, the reaction mixture was cooled to 0° C. and diluted with 20.0 mL of ethanol. 1.513 g of NaBH₄ (40.0 mmol) was added in portions to the reaction and stirred for another 24 h at rt. The solvent under vacuum was evaporated, and added ice was added to quench excess sodium borohydride followed by addition of water (100 mL). Reaction mixture was extracted with methylene chloride (3×100 mL) and then combined methylene chloride layer was washed with water (2×100 mL). The methylene chloride layer was dried on anhydrous sodium sulfate, filtered and evaporated under vacuum to give 5.87 g (100%) of (1R,2R)—N,N-Dibenzyl-1,2-diaminocyclohexane (2) as a colorless oil. 2 is a known compound. [α]_{D}²⁵=−83.9° (c=1.49, CHCl₃). ¹H NMR: 1.03 (m, 2H), 1.23 (m, 2H), 1.72 (m, 2H), 1.86 (br, 2H, 2×NH), 3.66 (d, 2H, J=13.5 Hz), 3.90 (d, 2H, J=13.5 Hz), 7.20-7.25 (m, 2H), 7.28-7.35 (m, 8H). ¹³C NMR: 25.0, 31.6, 50.9, 60.9, 126.7, 128.0, 128.3, 141.1.

### 2) Synthesis of Phosphoryl Chloride 3

To a solution of (1R,2R)—N,N-Dibenzyl-1,2-diaminocyclohexane (2, 5.87 g, 20.0 mmol) in methylene chloride (160.0 mL) was added 2.61 mL (28 mmol) of phosphorus oxychloride. Triethyl amine (6.69 mL, 48 mmol) was added drop wise to the reaction and was stirred at room temperature. After 24 h at RT, the reaction mixture was passed through a thick pad of silica gel (230-400 mesh) and washed with methylene chloride until all the product was obtained. Evaporation of solvent under vacuum gave 6.80 g (91%) of compound 3 as a white solid. mp 218-224° C. [α]D²⁵=−22.9° (c=1.09, CHCl₃). ¹H NMR: 0.95-1.04 (m, 1H), 1.06-1.28 (m, 3H), 1.59-1.70 (m, 3H), 1.72-1.80 (m, 1H), 2.88-3.02 (m, 2H), 3.74 (dd, 1H, J=7.5, 15.5 Hz), 4.21 (dd, 1H, J=10.5, 15.5 Hz), 4.44 (t, 1H, J=15.5 Hz), 4.51 (t, 1H, J=15.5 Hz), 7.24-7.36 (m, 6H), 7.39-7.46 (m, 4H). ¹³C NMR: 23.7, 24.1, 29.0 (d, J=7.9 Hz), 29.1 (d, J=12.9 Hz), 46.5 (d, J=4.4 Hz), 47.5 (d, J=2.4 Hz), 63.1 (d, J=10.4 Hz), 63.4 (d, J=10.4 Hz), 127.3, 127.4, 127.7 (2C), 127.9 (2C), 128.3 (2C), 128.5 (2C), 137.5 (d, J=3.5 Hz), 138.0 (d, J=9.9 Hz).

### 3) Synthesis of Phosphorus Azide 4

In a 250 mL round bottomed flask equipped with calcium chloride drying tube were taken 5.0 g of 3 (13.4 mmol) and 50.0 mL of N,N-Dimethylformamide. To this at rt was added 1.742 g of sodium azide (26.8 mmol). Reaction was heated at 70° C. for 5 h. After cooling to rt, 100 mL cold water was added to the reaction flask and the resulting solid was filtered and dried to obtain 5.08 g of compound 4 as a white solid. mp 145-148° C. [α]_{D}²⁵=−14.9° (c=1.14, CHCl₃). ¹H NMR: 0.99-1.24 (m, 4H), 1.60-1.83 (m, 4H), 2.82-2.96 (m, 2H), 3.96 (dd, 1H, J=8.5, 15.5 Hz), 4.11 (dd, 1H, J=12.5, 15.5 Hz), 4.36 (t, 2H, J=15.5 Hz), 7.24-7.30 (m, 2H), 7.31-7.36 (m, 4H), 7.41 (d, 2H, J=7.5 Hz), 7.44 (d, 2H, J=7.5 Hz). ¹³C NMR: 23.9, 24.0, 29.0 (t, J=8.9, 10.4 Hz, 2C), 46.6 (d, J=3.5 Hz), 46.7 (d, J=3.9 Hz), 63.0 (d, J=10.4 Hz), 63.5 (d, J=9.8 Hz), 127.3, 127.4, 127.7 (2C), 128.0 (2C), 128.4 (2C), 128.5 (2C), 137.7 (d, J=3.0 Hz), 138.0 (d, J=5.5 Hz).

### 4) Synthesis of Chiral Phosphoramide D1

Into a 250 mL round bottom flask equipped with H₂ balloon, was taken a solution of 5.0 g of 4 (13.4 mmol) in 100 mL of THF. To this was added 0.5 g of 10% palladium on charcoal. After stirring overnight at RT, the reaction mixture was diluted with methylene chloride and passed through a pad of celite. The filterate was dried on anhydrous sodium sulfate, filtered and evaporated under vacuum to give 4.65 g (100%) of pure product D1 as a white solid. mp 211-212° C.; [α]_{D}²⁵=−59.8° (c=0.64, CHCl₃); ¹H NMR: 0.95-1.24 (m, 4H), 1.60-1.80 (m, 4H), 2.50 (d, 2H, ²J_{PH}=4.5 Hz, —NH₂, exchanged in D₂O), 2.72-2.77 (m, 1H), 2.84-2.89 (m, 1H), 3.90 (dd, 1H, J=7.5, 16.0 Hz), 4.02 (dd, 1H, J=9.0, 16.0 Hz), 4.36-4.43 (m, 2H), 7.21-7.25 (m, 2H), 7.29-7.33 (m, 4H), 7.43 (t, 4H, J=7.5 Hz); ¹³C NMR: 24.1, 24.2, 29.4 (d, J=3.5 Hz), 29.5 (d, J=5.0 Hz), 46.7 (d, J=3.0 Hz), 46.8 (d, J=4.5 Hz), 62.7 (d, J=9.4 Hz), 63.7 (d, J=10.4 Hz), 126.8, 126.9, 127.7 (2C), 127.9 (2C), 128.2 (2C), 128.3 (2C), 139.4 (d, J=4.4 Hz), 139.7 (d, J=5.0 Hz).

The same synthesis afforded a derivative of D3: ¹H NMR (CDCl₃, 500 Hz): 8.14-8.17 (m, 2H), 7.82-7.86 (m, 2H), 7.71-7.75 (m, 4H), 7.46-7.52 (m, 6H), 4.81-4.89 (m, 2H), 4.82 (dd, J=12.5, 15.0 Hz, 1H), 4.31 (dd, J=5.5, 16.5 Hz, 1H), 3.05-3.10 (m, 1H), 2.91-2.95 (m, 1H), 2.42 (b, 2H), 1.81-1.82 (m, 1H), 1.54-1.62 (m, 3H), 1.04-1.25 (m, 4H); ¹³C NMR (CDCl₃, 125 Hz): 134.9, 134.9, 134.4, 134.4, 133.5, 133.4, 131.3, 131.0, 128.6, 128.5, 127.6, 127.4, 125.9, 125.8, 125.5, 125.4, 125.2, 125.2, 123.1, 123.0, 64.5, 64.4, 63.8, 63.7, 45.1, 45.0, 44.9, 44.9, 29.5, 29.4, 29.4, 24.1, 24.1.

### B. Synthesis of N,N′-di secondary alkyl-1,2-diaminocyclohexane (Formula (VI))

### 1) Synthesis of (1R,2R)—N,N′-1,2-diisopropyl-1,2-diaminocyclohexane 5

Into a 100 mL single-neck round bottom flask were added (1R,2R)-(−)-1,2-diaminocyclohexane 1 (1.90 g, 16.7 mmol), 40.0 mL of ethanol, 6.2 mL of acetone (83.9 mmol) and 0.1 g of PtO₂. H₂ balloon was attached to the flask and the reaction was stirred for 24 h at rt. Filtered off PtO₂ through a pad of celite and the filtrate was evaporated to give 3.31 g (100%) of (1R,2R)—N,N-diisopropyl-1,2-diaminocyclohexane (5) as a colorless oil.

### 2) Synthesis of Phosphoryl Chloride 6

To a solution of (1R,2R)—N,N-diisopropyl-1,2-diaminocyclohexane (5, 3.31 g, 16.7 mmol) in methylene chloride (103.0 mL) was added 2.20 mL (23.4 mmol) of phosphorus oxychloride. Triethyl amine (6.69 mL, 48 mmol) was added drop wise to the reaction at 0° C. The reaction temperature was then raised to rt and stirred for 24 h. The reaction mixture was passed through a thick pad of silica gel (230-400 mesh) and washed with methylene chloride until all the product was obtained. Evaporation of solvent under vacuum gave 4.65 g (100%) of compound 6 as a pale yellow oil. ¹H NMR: 3.63-3.56 (m, 2H), 3.056 (t, 1H, J=11.5 Hz), 2.92 (t, 1H, J=11.5 Hz), 2.18-2.10 (m, 1H), 2.10-1.98 (m, 1H), 1.94-1.76 (m, 2H), 1.43 (d, 3H, J=6.5 Hz), 1.37 (d, 3H, J=6.5 Hz), 1.42-1.30 (m, 3H), 1.26 (d, 3H, J=6.5 Hz), 1.28-1.26 (m, 1H), 1.24 (d, 3H, J=6.5 Hz); ¹³C NMR: 60.6 (d, J=10.4 Hz), 58.7 (d, J=11.8 Hz), 45.0, 29.6 (d, J=12.7 Hz), 29.2 (d, J=8.8 Hz), 24.0 (d, J=1.5 Hz), 23.9 (d, J=2.0 Hz), 21.39 (d, J=5.8 Hz), 21.34 (d, J=2.5 Hz), 20.2 (d, J=2.0 Hz), 19.2 (d, J=1.4 Hz).

### 3) Synthesis of Phosphorus Azide 7

In a 100 mL round bottomed flask equipped with calcium chloride drying tube were taken 4.65 g of 6 (16.7 mmol) and 65.0 mL of N,N-dimethylformamide. To this at rt was added 1.742 g of sodium azide (50.1 mmol). Reaction was heated at 70° C. for 5 h. After cooling to rt, 100 mL cold water was added to the reaction flask and transferred to a separatory funnel. The water layer was then extracted with ethyl acetate (3×200 mL) and combined organic layers was washed with water and dried on anhydrous sodium sulfate. Filtered off the sodium sulfate and evaporation of the solvent gave 4.76 g (100% yield) of phosphorus azide 7 as a pale yellow oil. ¹H NMR: 3.68-3.48 (m, 2H), 3.10-3.02 (t, 1H, J=11.5 Hz), 2.98-2.88 (t, 1H, J=11.5 Hz), 2.18-2.10 (m, 1H), 2.08-2.02 (m, 1H), 1.90-1.78 (m, 2H), 1.43 (d, 3H, J=7.0 Hz), 1.42-1.36 (m, 3H), 1.39 (d, 3H, J=7.0 Hz), 1.28-1.26 (m, 1H), 1.26 (d, 3H, J=6.5 Hz), 1.24 (d, 3H, J=6.5 Hz); ¹³C NMR: 60.6 (d, J=10.4 Hz), 58.8 (d, J=11.9 Hz), 45.0, 29.6 (d, J=12.9 Hz), 29.2 (d, J=8.9 Hz), 24.0 (d, J=1.5 Hz), 23.9 (d, J=2.0 Hz), 21.4 (d, J=6.0 Hz), 21.3 (d, J=2.5 Hz), 20.2 (d, J=2.5 Hz), 19.2 (d, J=1.5 Hz).

### 3) Synthesis of Chiral Phosphoramide D2

Into a 250 mL round bottom flask equipped was taken a solution of 4.76 g of 7 (16.7 mmol) in 100 mL of THF. To this was added 0.4 g of 10% palladium on charcoal and a H₂ balloon was attached. After stirring overnight at rt, the reaction mixture was diluted with methylene chloride and passed through a pad of celite. The filtrate was dried on anhydrous sodium sulfate, filtered and evaporated under vacuum to give 4.32 g (100%) of pure product D2 as a white solid. ¹H NMR: 3.58-3.42 (m, 2H), 2.92 (t, 1H, J=12.5 Hz), 2.70 (t, 1H, J=12.5 Hz), 2.47 (bs, 2H, —NH₂), 2.08-1.96 (m, 2H), 1.80-1.72 (m, 2H), 1.38 (d, 3H, J=7.0 Hz), 1.35-1.25 (m, 3H), 1.33 (d, 3H, J=7.0 Hz), 1.21 (d, 3H, J=4.5 Hz), 1.19 (d, 3H, J=4.5 Hz), 1.18-1.10 (m, 1H); ¹³C NMR: 59.7 (d, J=10.4 Hz), 58.8 (d, J=9.4 Hz), 44.4, 44.0 (d, J=3.4 Hz), 30.1 (d, J=5.9 Hz), 30.0 (d, J=6.9 Hz), 24.27, 24.26, 21.8 (d, J=2.5 Hz), 21.7 (d, J=2.9 Hz), 20.5 (d, J=1.0 Hz), 19.9 (d, J=1.5 Hz).

The same synthesis afforded other derivatives of D2 (formula (II)): D4: 59%, ¹H NMR 0.88-1.09 (m, 13H), 1.10-1.89 (m, 15H), 2.08 (d, 2H, ²J_{PH}=4.5 Hz), 2.60-3.08 (m, 4H). D5: 67%, ¹H NMR 1.05-2.10 (m, 24H), 2.40-2.50 (d, 2H, ²J_{PH}=4.5 Hz), 2.61-2.73 (m, 1H), 2.83-2.96 (m, 1H), 3.35-3.58 (m, 2H). D6: 64%, ¹H NMR 1.05-2.15 (m, 28H), 2.40-2.50 (d, 2H, ²J_{PH}=4.5 Hz), 2.69-2.81 (m, 1H), 2.90-3.13 (m, 3H).

### Synthesis of chiral N-phosphonyl imines (Formula (VII))

### A. Synthesis of N,N′-di-primary alkyl-N-phosphonyl imines (Table 1&2)

Typical procedure for synthesis of chiral N-phosphonyl imines: Into a dried and nitrogen flushed round bottom flask were loaded chiral phosphoramide D1 (1.07 g, 3.0 mmol), aldehyde (3.0 mmol) and CH₂Cl₂ (15.0 mL). The resulting mixture was protected by nitrogen and was cooled to 0° C. prior to the addition of DIPEA (1.56 mL, 9.0 mmol). Into the above mixture was added dropwise a solution of TiClₐ in CH₂Cl₂ (1 M, 1.5 mmol). The reaction was stirred at 0° C. for 30 min and at rt for 48 h. The clear solution of the crude reaction mixture was directly transferred to silica gel (200-300 mesh) packed in column for chromatography and eluted by mixed solvents of hexanes/EtOAc/Et₃N (v/v/v, 90:9:1 to 60:38:2) to give imine products as viscous oils.

Compound 7: [α]_{D}²⁵=+12.4° (c=1.73, CHCl₃); ¹H NMR: 1.00-1.25 (m, 4H), 1.63-1.73 (m, 3H), 1.86-1.89 (m, 1H), 2.94-3.04 (m, 2H), 3.89 (dd, 1H, J=7.5, 15.5 Hz), 4.03 (dd, 1H, J=12.0, 15.5 Hz), 4.30 (dd, 1H, J=12.0, 15.5 Hz), 4.39 (dd, 1H, J=12.5, 15.5 Hz), 7.15-7.20 (m, 2H), 7.23-7.27 (m, 5H), 7.41-7.47 (m, 6H), 7.83 (d, 2H, J=8.0 Hz), 8.76 (d, 1H, ³J_{PH}=33.0 Hz); ¹³C NMR: 24.21, 24.27, 29.4 (d, J=9.4 Hz), 29.6 (d, J=8.9 Hz), 46.9 (d, J=3.0 Hz), 47.5 (d, J=3.5 Hz), 63.4 (d, J=8.9 Hz), 63.8 (d, J=7.9 Hz), 126.8, 126.9, 127.8 (2C), 128.12 (2C), 128.19 (2C), 128.4 (2C), 128.6 (2C), 130.0, 132.9, 135.7, 136.0, 138.7 (d, J=3.5 Hz), 139.3 (d, J=4.9 Hz), 173.6 (d, J=7.0 Hz).

Compound 8: [α]_{D}²⁵=−1.85° (c=2.16, CHCl₃); ¹H NMR: 1.06-1.25 (m, 4H), 1.60-1.73 (m, 3H), 1.85-1.87 (m, 1H), 2.93-3.05 (m, 2H), 3.87 (s, 3H, —OCH₃), 3.85-3.90 (dd, 1H, merged with methyl group of methoxy), 4.02 (dd, 1H, J=12.0, 15.0 Hz), 4.28 (dd, 1H, J=12.0, 16.0 Hz), 4.39 (dd, 1H, J=12.5, 15.5 Hz), 6.95 (d, 2H, J=9.0 Hz), 7.15-7.20 (m, 2H), 7.23-7.27 (m, 4H), 7.41-7.46 (m, 4H), 7.79 (d, 2H, J=9.0 Hz), 8.70 (d, 1H, ³J_{PH}=32.5 Hz); ¹³C NMR: 24.22, 24.27, 29.4 (d, J=9.4 Hz), 29.6 (d, J=8.9 Hz), 46.9 (d, J=3.0 Hz), 47.5 (d, J=3.4 Hz), 55.4, 63.4 (d, J=8.5 Hz), 63.8 (d, J=7.9 Hz), 114.0 (2C), 126.8, 126.9, 127.8 (2C), 128.0 (2C), 128.1 (2C), 128.3 (2C), 128.8, 129.1, 132.0, 138.9 (d, J=3.4 Hz), 139.4 (d, J=5.0 Hz), 163.6, 172.9 (d, J=6.4 Hz).

Compound 9: [α]_{D}²⁵=−15.87° (c=0.46, CHCl₃); ¹H NMR: 1.00-1.21 (m, 4H), 1.60-1.74 (m, 3H), 1.85-1.87 (m, 1H), 2.90-3.03 (m, 2H), 3.88 (dd, 1H, J=7.5, 15.5 Hz), 4.01 (dd, 1H, J=12.0, 15.5 Hz), 4.26 (dd, 1H, J=12.0, 16.0 Hz), 4.38 (dd, 1H, J=13.0, 16.0 Hz), 5.14 (s, 2H, —OCH₂—), 7.03 (d, 2H, J=9.0 Hz), 7.15-7.20 (m, 2H), 7.23-7.27 (m, 5H), 7.39-7.45 (m, 8H), 7.79 (d, 2H, J=9.0 Hz), 8.70 (d, 1H, ³J_{PH}=33.0 Hz); ¹³C NMR: 24.23, 24.28, 29.4 (d, J=9.4 Hz), 29.6 (d, J=8.9 Hz), 46.9 (d, J=3.0 Hz), 47.5 (d, J=3.4 Hz), 63.4 (d, J=8.9 Hz), 63.8 (d, J=7.9 Hz), 70.1, 114.9 (2C), 126.8, 126.9, 127.4 (2C), 127.8 (2C), 128.0 (2C), 128.1 (2C), 128.2, 128.3 (2C), 128.6 (2C), 129.1, 129.3, 132.0, 136.1, 138.9 (d, J=3.5 Hz), 139.4 (d, J=4.8 Hz), 162.7, 172.9 (d, J=6.4 Hz).

Compound 10: ¹H NMR: 1.00-1.21 (m, 4H), 1.62-1.74 (m, 3H), 1.85-1.87 (m, 1H), 2.42 (s, 3H, —CH₃) 2.93-3.03 (m, 2H), 3.88 (dd, 1H, J=8.0, 16.0 Hz), 4.02 (dd, 1H, J=12.0, 15.5 Hz), 4.28 (dd, 1H, J=12.0, 16.0 Hz), 4.39 (dd, 1H, J=13.0, 15.5 Hz), 7.15-7.20 (m, 2H), 7.23-7.26 (m, 6H), 7.41-7.43 (m, 4H), 7.74 (d, 2H, J=8.0 Hz), 8.74 (d, 1H, ³J_{PH}=33.0 Hz); ¹³C NMR: 21.7, 24.21, 24.27, 29.4 (d, J=9.4 Hz), 29.6 (d, J=8.9 Hz), 46.9 (d, J=3.0 Hz), 47.5 (d, J=3.4 Hz), 63.3 (d, J=8.9 Hz), 63.8 (d, J=7.9 Hz), 126.8, 126.9, 127.8 (2C), 128.10 (2C), 128.17 (2C), 128.3 (2C), 129.4 (2C), 130.0, 133.3, 133.5, 138.8 (d, J=3.4 Hz), 139.3 (d, J=4.9 Hz), 143.8, 173.6 (d, J=6.9 Hz)

Compound 11: ¹H NMR: 1.04-1.25 (m, 4H), 1.60-1.71 (m, 3H), 1.86-1.88 (m, 1H), 2.48 (s, 3H, —CH₃) 2.94 (m, 1H), 3.03 (m, 1H), 3.85 (dd, 1H, J=7.5, 16.0 Hz), 4.02 (dd, 1H, J=12.0, 15.5 Hz), 4.32 (dd, 1H, J=11.5, 16.0 Hz), 4.44 (dd, 1H, J=13.0, 15.5 Hz), 7.17-7.30 (m, 7H), 7.38-7.43 (m, 6H), 8.00 (d, 1H, J=7.5 Hz), 9.10 (d, 1H, ³J_{PH}=33.0 Hz); ¹³C NMR: 19.4, 24.22, 24.29, 29.5 (d, J=9.4 Hz), 29.8 (d, J=8.9 Hz), 47.1 (d, J=3.0 Hz), 47.6 (d, J=3.5 Hz), 63.5 (d, J=8.4 Hz), 64.1 (d, J=7.9 Hz), 126.1, 126.8, 126.9, 127.7 (2C), 128.12 (2C), 128.19 (2C), 128.2 (2C), 129.1, 131.1 (d, J=1.5 Hz), 132.5, 133.6, 139.0 (d, J=3.5 Hz), 139.4 (d, J=5.5 Hz), 140.5, 172.1 (d, J=6.9 Hz).

Compound 12: ¹H NMR 1.07-1.25 (m, 4H), 1.64-1.74 (m, 3H), 1.88-1.90 (m, 1H), 2.94-3.04 (m, 2H), 3.89 (dd, 1H, J=8.0, 16.0 Hz), 4.03 (dd, 1H, J=13.0, 15.0 Hz), 4.28 (dd, 1H, J=12.0, 16.0 Hz), 4.37 (dd, 1H, J=12.5, 15.5 Hz), 7.11-7.21 (m, 4H), 7.23-7.27 (m, 4H), 7.41 (m, 4H), 7.82 (t, 2H, J=7.5 Hz), 8.67 (d, 1H, ³J_{PH}=32.5 Hz); ¹³C NMR 24.21, 24.27, 29.3 (d, J=9.4 Hz), 29.6 (d, J=9.4 Hz), 46.8 (d, J=3.0 Hz), 47.4 (d, J=3.4 Hz), 63.3 (d, J=8.9 Hz), 63.8 (d, J=7.9 Hz), 115.8, 116.0, 126.9, 127.0, 127.8 (2C), 128.14 (2C), 128.19 (2C), 128.4 (2C), 132.1, 132.2, 132.4, 138.6 (d, J=3.5 Hz), 139.2 (d, J=4.9 Hz), 165.7 (d, J_{CF}=253.7 Hz), 172.1 (d, J=7.0 Hz).

Compound 13: ¹H NMR 1.08-1.26 (m, 4H), 1.65-1.76 (m, 3H), 1.90-1.92 (m, 1H), 2.94-3.05 (m, 2H), 3.89 (dd, 1H, J=8.0, 16.0 Hz), 4.03 (dd, 1H, J=13.0, 15.0 Hz), 4.28 (dd, 1H, J=12.0, 15.5 Hz), 4.37 (dd, 1H, J=12.0, 15.0 Hz), 7.16-7.22 (m, 2H), 7.23-7.28 (m, 4H), 7.40-7.44 (m, 6H), 7.75 (d, 2H, J=8.5 Hz), 8.66 (d, 1H, ³J_{PH}=32.0 Hz); ¹³C NMR: 24.21, 24.27, 29.3 (d, J=9.4 Hz), 29.6 (d, J=9.0 Hz), 46.7 (d, J=3.4 Hz), 47.4 (d, J=3.4 Hz), 63.3 (d, J=8.4 Hz), 63.9 (d, J=7.9 Hz), 126.9, 127.0, 127.8 (2C), 128.16 (2C), 128.21 (2C), 128.4 (2C), 129.0 (2C), 131.0, 134.2, 134.4, 138.6 (d, J=3.0 Hz), 139.1 (d, J=5.0 Hz), 139.2, 172.1 (d, J=6.4 Hz).

Compound 14: ¹H NMR 1.00-1.19 (m, 4H), 1.62-1.72 (m, 3H), 1.87-1.89 (m, 1H), 2.82-2.87 (m, 1H), 2.95-3.01 (m, 1H), 3.85 (dd, 1H, J=7.0, 16.0 Hz), 4.06 (dd, 1H, J=11.5, 15.5 Hz), 4.37-4.46 (m, 2H), 7.16-7.22 (m, 2H), 7.25-7.28 (m, 4H), 7.34 (t, 1H, J=7.5 Hz), 7.39-7.46 (m, 6H), 8.17 (dd, 1H, J=1.5, 8.0 Hz), 9.25 (d, 1H, ³J_{PH}=32.0 Hz); ¹³C NMR 24.17, 24.26, 29.3 (d, J=9.9 Hz), 29.7 (d, J=8.9 Hz), 46.8 (d, J=3.5 Hz), 47.7 (d, J=3.0 Hz), 63.1 (d, J=8.9 Hz), 63.9 (d, J=7.9 Hz), 126.9, 127.0, 127.7 (2C), 128.16 (2C), 128.28 (2C), 128.3 (2C), 129.2, 130.1, 132.7, 132.9, 133.7, 137.8, 138.6 (d, J=3.5 Hz), 139.3 (d, J=4.9 Hz), 168.7 (d, J=5.4 Hz).

Compound 15: [α]_{D}²⁵=+10.00° (c=2.10, CHCl₃); ¹H NMR 1.09-1.23 (m, 4H), 1.64-1.75 (m, 3H), 1.89-1.91 (m, 1H), 2.93-3.04 (m, 2H), 3.89 (dd, 1H, J=7.5, 16.0 Hz), 4.02 (dd, 1H, J=13.5, 15.0 Hz), 4.27 (dd, 1H, J=12.0, 16.0 Hz), 4.36 (dd, 1H, J=12.0, 15.0 Hz), 7.15-7.27 (m, 2H), 7.23-7.27 (m, 4H), 7.39-7.42 (m, 4H), 7.59 (d, 2H, J=8.0 Hz), 7.66 (d, 2H, J=8.0 Hz), 8.63 (d, 1H, ³J_{PH}=32.5 Hz); ¹³C NMR 24.18, 24.25, 29.3 (d, J=9.4 Hz), 29.5 (d, J=9.4 Hz), 46.7 (d, J=3.0 Hz), 47.4 (d, J=3.5 Hz), 63.3 (d, J=8.9 Hz), 63.8 (d, J=8.4 Hz), 126.9, 127.0, 127.8 (2C), 128.15 (2C), 128.20 (2C), 128.4 (2C), 131.2 (2C), 132.0 (2C), 134.5, 134.8, 138.5 (d, J=2.9 Hz), 139.1 (d, J=4.4 Hz), 172.2 (d, J=7.0 Hz).

Compound 16: [α]_{D}²⁵=+20.8° (c=0.72, CHCl₃); ¹H NMR 1.10-1.24 (m, 4H), 1.60-1.73 (m, 3H), 1.83-1.85 (m, 1H), 2.96-3.03 (m, 2H), 3.93 (dd, 1H, J=8.0, 16.0 Hz), 4.01 (dd, 1H, J=12.5, 15.5 Hz), 4.23 (dd, 1H, J=12.5, 16.0 Hz), 4.397 (dd, 1H, J=12.5, 15.5 Hz), 7.13 (t, 1H, J=5.0 Hz), 7.15-7.21 (m, 2H), 7.24-7.28 (m, 4H), 7.41-7.45 (m, 4H), 7.47 (dd, 1H, J=3.5, 1.0 Hz), 7.62 (d, 1H, J=5.0 Hz) 8.83 (d, 1H, ³J_{PH}=31.5 Hz); ¹³C NMR 24.23 (2C), 29.3 (d, J=9.4 Hz), 29.5 (d, =9.4 Hz), 46.7 (d, J=3.0 Hz), 47.2 (d, =3.4 Hz), 63.1 (d, J=8.4 Hz), 63.8 (d, J=8.4 Hz), 126.8, 126.9, 127.9 (2C), 128.13 (2C), 128.16 (2C), 128.3 (2C), 133.0, 135.5, 138.8 (d, J=2.9 Hz), 139.1 (d, J=4.4 Hz), 142.9, 143.1, 166.1 (d, J=5.5 Hz).

Compound 17: 76% Yield (825 mg). mp: 69-71° C. [α]_{D}²⁵=−21.5° (c=0.58, CHCl₃); ¹H NMR (300 MHz, CDCl₃) δ 8.34 (d, J=33.0 Hz, 1H), 8.22 (d, J=8.1 Hz, 1H), 8.13 (d, J=8.4 Hz, 1H), 7.53-7.87 (m, 5H), 7.64 (d, J=8.1 Hz, 1H), 7.36-7.57 (m, 11H), 4.87 (dd, J=9.3, 15.0 Hz, 1H), 4.72 (dd, J=11.1, 16.2 Hz, 1H), 4.58 (t, J=16.2 Hz, 1H), 4.36 (dd, J=8.1, 15.9 Hz, 1H), 3.16-3.31 (m, 2H), 2.07-2.10 (m, 1H), 1.66-1.78 (m, 3H), 1.17-1.45 (m, 4H); ¹³C NMR (125 MHz, CDCl₃) δ 173.9 (d, J=6.5 Hz), 135.5 (d, J=28.1 Hz), 134.5, 134.5, 133.6, 133.5, 133.5, 132.8, 131.5, 131.2, 129.7, 128.5, 128.5, 128.4, 127.9, 127.6, 127.3, 126.0, 125.9, 125.9, 125.4, 125.4, 125.2, 125.2, 123.4, 123.4, 64.9 (d, J=7.3 Hz), 64.2 (d, J=8.3 Hz), 45.9, 45.8, 45.1, 45.1, 29.7, 29.6, 29.4, 29.4, 24.3; ³¹P NMR (202 MHz, CDCl₃) δ 28.9.

Compound 18: 80% Yield (917 mg). mp: 61-63° C. [α]_{D}²⁵=+3.4° (c=0.51, CHCl₃); ¹H NMR (300 MHz, CDCl₃) δ 9.15 (d, J=33.3 Hz, 1H), 8.24 (d, J=7.8 Hz, 1H), 8.13 (d, J=7.8 Hz, 1H), 7.99 (dd, J=1.2, 7.5 Hz, 1H), 7.75-7.85 (m, 5H), 7.66 (d, 1H, J=8.1 Hz), 7.39-7.57 (m, 7H), 6.97-7.02 (m, 1H), 6.86 (d, J=8.7, 1H), 4.97 (dd, J=10.5, 15.9 Hz, 1H), 4.72 (dd, J=11.1, 16.2 Hz, 1H), 4.48 (dd, J=12.6, 15.9 Hz, 1H), 4.33 (dd, J=7.5, 16.2 Hz, 1H), 3.77 (s, 3H), 3.19-3.31 (m, 2H), 1.89-1.92 (m, 1H), 1.62-1.73 (m, 3H), 1.14-1.39 (m, 4H); ¹³C NMR (125 MHz, CDCl₃) δ 170.3 (d, J=5.3 Hz), 160.7, 134.8, 134.8, 134.5, 134.3, 134.3, 133.5, 133.4, 131.2, 131.2, 128.5, 128.4, 128.0, 127.5, 127.4, 126.2, 125.9, 125.9, 125.8, 125.4, 125.3, 125.2, 125.1, 124.4, 124.1, 123.4, 123.3, 120.3, 110.9, 110.9, 65.3 (d, J=7.8 Hz), 64.3 (d, J=8.0 Hz), 55.2, 45.9, 45.8, 45.2, 45.1, 30.0, 29.9, 29.5, 29.4, 24.3; ³¹P NMR (202 MHz, CDCl₃) δ 30.7.

Compound 19: 81% Yield (902 mg). mp: 59-60° C. [α]_{D}²⁵=−7.14° (c=0.63, CHCl₃); ¹H NMR (300 MHz, CDCl₃) δ 8.34 (d, J=33.0 Hz, 1H), 8.18 (d, J=8.4 Hz, 1H), 8.09 (d, J=8.7 Hz, 1H), 7.71-7.83 (m, 5H), 7.64 (d, J=8.4 Hz, 1H), 7.33-7.51 (m, 8H), 7.15 (d, J=8.1, 2H), 4.82 (dd, J=9.3, 15.0 Hz, 1H), 4.72 (dd, J=10.5, 16.2 Hz, 1H), 4.47 (t, J=15.6 Hz, 1H), 4.28 (dd, J=8.1, 16.2 Hz, 1H), 3.11-3.28 (m, 2H), 2.38 (s, 3H), 1.99-2.04 (m, 1H), 1.61-1.73 (m, 3H), 1.09-1.45 (m, 4H); ¹³C NMR (125 MHz, CDCl₃) δ 173.9 (d, J=6.9 Hz), 143.7, 134.6, 134.6, 133.8, 133.7, 133.5, 133.4, 133.3, 133.0, 131.4, 131.2, 129.8, 129.2, 128.5, 128.5, 127.8, 127.6, 127.1, 125.9, 125.9, 125.8, 125.4, 125.3, 125.2, 125.2, 123.4, 123.4, 65.0 (d, J=7.4 Hz), 64.2 (d, J=7.9 Hz), 45.9, 45.8, 45.2, 45.1, 29.7, 29.6, 29.5, 29.4, 24.3, 21.7; ³¹P NMR (202 MHz, CDCl₃) δ 30.4.

Compound 20: 77% Yield (864 mg). mp: 48-50° C. [α]_{D}²⁵=−14.8° (c=0.51, CHCl₃); ¹H NMR (300 MHz, CDCl₃) δ 8.68 (d, J=33.0 Hz, 1H), 8.22 (d, J=8.1 Hz, 1H), 8.13 (d, J=8.1 Hz, 1H), 7.65-7.87 (m, 7H), 7.37-7.57 (m, 7H), 7.12-7.17 (m, 1H), 7.00-7.06 (m, 1H), 4.84 (dd, J=9.3, 15.0 Hz, 1H), 4.72 (dd, J=10.8, 15.9 Hz, 1H), 4.58 (t, J=15.9 Hz, 1H), 4.36 (dd, J=8.1, 16.2 Hz, 1H), 3.16-3.31 (m, 2H), 2.05-2.10 (m, 1H), 1.66-1.79 (m, 3H), 1.17-1.46 (m, 4H); ¹³C NMR (125 MHz, CDCl₃) δ 167 (t, J=5.5 Hz), 164.5, 162.5, 134.6, 134.5, 134.5, 134.4, 133.5, 133.4, 133.4, 133.4, 131.4, 131.2, 128.5, 128.4, 128.2, 127.9, 127.7, 127.1, 125.9, 125.8, 125.4, 125.3, 125.1, 125.1, 124.0, 124.0, 123.3, 123.3, 115.8, 115.7, 64.9 (d, J=7.5 Hz), 64.2 (d, J=8.3 Hz), 45.9, 45.8, 44.9, 44.9, 29.7, 29.6, 29.4, 29.3, 24.3; ³¹P NMR (202 MHz, CDCl₃) δ 29.8.

Compound 21: 70% Yield (871 mg). mp: 59-61° C. [α]_{D}²⁵=−22.5° (c=0.60, CHCl₃); ¹H NMR (300 MHz, CDCl₃) δ 8.81 (d, J=32.1 Hz, 1H), 8.23 (d, J=8.4 Hz, 1H), 8.13 (d, J=8.4 Hz, 1H), 7.67-7.87 (m, 7H), 7.40-7.57 (m, 7H), 7.31-7.39 (m, 2H), 4.93 (dd, J=9.6, 15.3 Hz, 1H), 4.75 (dd, J=11.1, 16.2 Hz, 1H), 4.58 (t, J=15.3 Hz, 1H), 4.36 (dd, J=7.2, 16.2 Hz, 1H), 3.09-3.30 (m, 2H), 2.03-2.08 (m, 1H), 1.66-1.78 (m, 3H), 1.15-1.48 (m, 4H); ¹³C NMR (125 MHz, CDCl₃) δ 171.7 (d, J=5.4 Hz), 134.5, 134.5, 134.1, 133.9, 133.6, 133.6, 133.6, 133.5, 133.1, 131.2, 131.2, 129.5, 128.5, 127.9, 127.7, 127.5, 127.3, 127.0, 126.0, 125.9, 125.9, 125.5, 125.4, 125.2, 123.4, 123.3, 65.2 (d, J=7.3 Hz), 63.9 (d, J=8.3 Hz), 46.1, 46.0, 44.9, 44.9, 29.9, 29.8, 29.4, 29.3, 24.2; ³¹P NMR (202 MHz, CDCl₃) δ 29.5.

Compound 22: 72% Yield (832 mg). mp: 53-55° C. [α]_{D}²⁵=−26.7° (c=0.60, CHCl₃); ¹H NMR (300 MHz, CDCl₃) δ 8.81 (d, J=32.1 Hz, 1H), 8.19 (d, J=8.1 Hz, 1H), 8.08 (d, J=8.7 Hz, 1H), 7.63-7.85 (m, 7H), 7.35-7.55 (m, 7H), 7.25-7.31 (m, 1H), 7.20-7.23 (m, 1H), 4.87 (dd, J=9.6, 15.3 Hz, 1H), 4.72 (dd, J=10.8, 15.9 Hz, 1H), 4.53 (t, J=15.6 Hz, 1H), 4.36 (dd, J=7.5, 15.5 Hz, 1H), 3.07-3.27 (m, 2H), 2.01-2.04 (m, 1H), 1.63-1.74 (m, 3H), 1.12-1.42 (m, 4H); ¹³C NMR (125 MHz, CDCl₃) δ 169.6 (d, J=5.0 Hz), 137.6, 134.5, 134.5, 133.6, 133.5, 133.5, 132.7, 132.7, 131.4, 131.2, 129.8, 129.8, 129.0, 128.5, 128.5, 127.9, 127.7, 127.0, 126.7, 125.9, 125.9, 125.9, 125.4, 125.4, 125.2, 125.1, 123.3, 123.3, 65.2 (d, J=7.3 Hz), 64.0 (d, J=8.4 Hz), 46.0, 46.0, 44.9, 44.9, 29.8, 29.7, 29.4, 29.3, 24.3, 24.2; ³¹P NMR (202 MHz, CDCl₃) δ 29.8.

Compound 23: 83% Yield (925 mg). mp: 55-58° C. [α]_{D}²⁵=−9.6° (c=0.62, CHCl₃); ¹H NMR (300 MHz, CDCl₃) δ 8.70 (d, J=33.3 Hz, 1H), 8.22 (d, J=8.4 Hz, 1H), 8.09 (d, J=8.4 Hz, 1H), 7.69-7.84 (m, 6H), 7.64 (d, J=8.1 Hz, 1H), 7.31-7.54 (m, 7H), 7.16-7.21 (m, 1H), 7.09 (d, J=7.5 Hz, 1H), 4.87 (dd, J=9.6, 15.3 Hz, 1H), 4.67 (dd, J=10.5, 15.9 Hz, 1H), 4.52 (t, J=15.3 Hz, 1H), 4.36 (dd, J=7.8, 16.2 Hz, 1H), 3.11-3.29 (m, 2H), 2.25 (s, 3H), 1.99-2.03 (m, 1H), 1.63-1.74 (m, 3H), 1.13-1.40 (m, 4H); ¹³C NMR (125 MHz, CDCl₃) δ 172.5 (d, J=6.4 Hz), 140.4, 134.6, 134.5, 133.9, 133.8, 133.6, 133.5, 133.4, 133.4, 132.4, 131.4 131.2, 130.9, 130.9, 129.2, 128.5, 128.5, 127.7, 127.6, 126.9, 125.9, 125.9, 125.4, 125.4, 125.2, 125.1, 123.3, 123.3, 65.1 (d, J=7.5 Hz), 64.2 (d, J=7.9 Hz), 45.9, 45.9, 45.2, 45.2, 29.8, 29.8, 29.4, 29.4, 24.3, 19.2; ³¹P NMR (202 MHz, CDCl₃) δ 30.2

Compound 24: 61% Yield (697 mg). mp: 53-55° C. [α]_{D}²⁵=+4.7° (c=0.66, CHCl₃); ¹H NMR (300 MHz, CDCl₃) δ 9.01 (d, J=35.7 Hz, 1H), 8.22 (d, J=7.5 Hz, 1H), 8.09 (d, J=7.8 Hz, 1H), 7.73-7.85 (m, 5H), 7.65 (d, J=8.4 Hz, 1H), 7.36-7.57 (m, 6H), 7.17-7.22 (m, 1H), 6.98 (d, J=7.5 Hz, 2H), 4.98 (dd, J=10.2, 15.9 Hz, 1H), 4.72 (dd, J=10.8, 16.2 Hz, 1H), 4.45 (t, J=13.8 Hz, 1H), 4.24 (dd, J=7.2, 16.2 Hz, 1H), 3.05-3.27 (m, 2H), 2.32 (s, 6H), 1.93-1.97 (m, 1H), 1.43-1.71 (m, 3H), 1.12-1.43 (m, 4H); ¹³C NMR (125 MHz, CDCl₃) δ 174.0 (d, J=8 Hz), 140.4, 134.7, 134.6, 134.2, 134.2, 133.5, 133.5, 132.3, 132.1, 131.2, 131.1, 129.1, 128.5, 128.5, 127.7, 127.6, 126.3, 125.9, 125.9, 125.8, 125.4, 125.2, 125.1, 123.2, 123.1, 65.5 (d, J=7.5 Hz), 64.3 (d, J=7.8 Hz), 46.0, 46.0, 45.5, 45.5, 30.2, 30.1, 29.6, 29.5, 24.2, 21.4; ³¹P NMR (202 MHz, CDCl₃) δ 30.2

Compound 25: 68% Yield (807 mg). mp: 48-50° C. [α]²_{z}; =+10.8° (c=0.74, CHCl₃); ¹H NMR (300 MHz, CDCl₃) δ 8.92 (d, J=34.2 Hz, 1H), 8.63-8.66 (m, 1H), 8.22 (d, J=8.1 Hz, 1H), 8.14 (d, J=8.4 Hz, 1H), 7.93 (d, J=8.1 Hz, 1H), 7.71-7.83 (m, 5H), 7.55-7.63 (m, 2H), 7.30-7.54 (m, 10H), 4.87 (dd, J=9.3, 15.0 Hz, 1H), 4.73 (dd, J=10.8, 16.2 Hz, 1H), 4.53 (t, J=16.2 Hz, 1H), 4.33 (dd, J=8.1, 15.9 Hz, 1H), 3.14-3.33 (m, 2H), 2.08-2.12 (m, 1H), 1.64-1.78 (m, 3H), 1.16-1.45 (m, 4H); ¹³C NMR (125 MHz, CDCl₃) δ 173.2 (d, J=7 Hz), 134.5, 134.5, 133.7, 133.6, 133.5, 133.5, 132.1, 131.5, 131.5, 131.2, 130.7, 130.5, 128.5, 128.5, 128.4, 127.9, 127.7, 127.6, 127.4, 126.2, 126.0, 125.9, 125.4, 125.3, 125.2, 125.2, 124.9, 124.2, 123.4, 123.3, 65.1 (d, J=6.9 Hz), 64.2 (d, J=7.2 Hz), 46.0, 45.9, 45.2, 45.2, 29.8, 29.7, 29.4, 29.4, 24.3, 24.2; ³¹P NMR (202 MHz, CDCl₃) δ 30.1.

### B. Synthesis of N,N′-di-secondary alkyl-N-phosphonyl imines (Table 3)

Into a dried and nitrogen flushed round bottom flask were loaded chiral phosphoramide D3 (0.2 g, 0.77 mmol), aldehyde (0.77 mmol) and CH₂Cl₂ (2.8 mL). The resulting mixture was protected by nitrogen and was cooled to 0° C. prior to the addition of Et₃N (0.32 mL, 2.31 mmol). Into the above mixture was added dropwise a solution of TiCl₄ in CH₂Cl₂ (1 M, 0.38 mmol). The reaction was stirred at 0° C. for 30 min and at rt for 48 h. The clear solution of the crude reaction mixture was directly transferred to silica gel (200-300 mesh) packed in column for chromatography and eluted by mixed solvents of hexanes/EtOAc/Et₃N (v/v/v, 90:9:1 to 60:38:2) to give imine products. Most of the products were obtained as white solids.

Compound 26: [α]_{D}²⁵=−12.2° (c=0.53, CHCl₃); ¹H NMR 9.03 (d, 1H, J=33.0 Hz), 7.96-7.88 (m, 2H), 7.56-7.52 (m, 1H), 7.51-7.45 (m, 2H), 3.50-3.34 (m, 2H), 3.09 (t, 1H, J=12 Hz), 2.84 (t, 1H, J=12 Hz), 2.12-2.02 (m, 2H), 1.86-1.75 (m, 2H), 1.45-1.31 (m, 3H), 1.30-1.22 (m, 10H), 1.11 (d, 3H, J=7.0 Hz); ¹³C NMR 171.5 (d, J=7.4 Hz), 136.2 (d, J=27.8 Hz), 132.7, 130.0 (2C), 128.7 (2C), 59.8 (d, J=8.4 Hz), 59.3 (d, J=8.9 Hz), 45.1, 44.5, 29.6 (d, J=10.0 Hz), 29.5 (d, J=9.4 Hz), 24.3, 24.2, 21.8 (d, J=3.5 Hz), 20.9 (d, J=3.0 Hz), 20.6, 20.4.

Compound 27: [α]_{D}²⁵=−86.1° (c=0.26, CHCl₃); ¹H NMR 8.96 (d, 1H, J=33.5 Hz), 7.88 (d, 2H, J=9.0 Hz), 6.97 (d, 2H, J=9.0 Hz), 3.87 (s, 3H), 3.50-3.33 (m, 2H), 3.08 (t, 1H, J=12 Hz), 2.85 (t, 1H, J=12 Hz), 2.10-2.04 (m, 2H), 1.90-1.79 (m, 2H), 1.40-1.31 (m, 3H), 1.30-1.20 (m, 10H), 1.11 (d, 3H, J=6.5 Hz); ¹³C NMR 170.9 (d, J=4.1 Hz), 163.4, 132.0 (2C), 129.3 (d, J=28.1 Hz), 114.1 (2C), 59.7 (d, J=7.8 Hz), 59.3 (d, J=8.8 Hz), 55.4, 45.1 (d, J=3.0 Hz), 44.4 (d, J=3.5 Hz), 29.7 (d, J=9.3 Hz), 29.4 (d, J=5.3 Hz), 24.3 (d, J=6.3 Hz), 21.7 (d, J=3.3 Hz), 20.8 (d, J=3.0 Hz), 20.6, 20.4.

Compound 28: [α]_{D}²⁵−32.3° (c=0.73, CHCl₃); ¹H NMR 8.98 (d, 1H, J=33.5 Hz), 7.82 (d, 2H, J=8.0 Hz), 7.27 (d, 2H, J=8.0 Hz), 3.50-3.30 (m, 2H), 3.08 (t, 1H, J=12.0 Hz), 2.84 (t, 1H, J=12.0 Hz), 2.42 (s, 3H), 2.12-2.00 (m, 2H), 1.86-1.78 (m, 2H), 1.45-1.30 (m, 3H), 1.30-1.20 (m, 10H), 1.10 (d, 3H, J=6.5 Hz); ¹³C NMR 171.4 (d, J=7.7 Hz), 143.5, 133.7 (d, J=27.7 Hz), 130.0 (2C), 129.4 (2C), 59.7 (d, J=8.2 Hz), 59.3 (d, J=8.8 Hz), 45.1 (d, J=2.8 Hz), 44.5 (d, J=2.8 Hz), 29.6 (d, J=9.3 Hz), 29.4 (d, J=9.3 Hz), 24.3 (d, J=5.3 Hz), 21.78 (d, J=3.0 Hz), 21.71, 20.9 (d, J=2.8 Hz), 20.6, 20.4.

Compound 29: [α]_{D}²⁵=−20.9° (c=0.11, CHCl₃); ¹H NMR 9.36 (d, 1H, J=33.5 Hz), 8.06 (d, 1H, J=7.5 Hz), 7.40 (t, 1H, J=7.5 Hz), 7.28 (t, 1H, J=7.5 Hz), 7.23 (d, 1H, J=7.5 Hz), 3.60-3.38 (m, 2H), 3.09 (t, 1H, J=12 Hz), 2.80 (t, 1H, J=12 Hz), 2.62 (s, 3H), 2.10-2.00 (m, 2H), 1.90-1.78 (m, 2H), 1.45-1.20 (m, 13H), 1.12 (d, 3H, J=6.5 Hz); ¹³C NMR 169.7 (d, J=7.3 Hz), 140.2, 133.9 (d, J=26.6 Hz), 132.3, 131.0, 128.7, 126.3, 131.0 (d, J=1.0 Hz), 59.7 (d, J=7.8 Hz), 59.3 (d, J=8.8 Hz), 45.1 (d, J=3.0 Hz), 44.5 (d, J=2.8 Hz), 29.7 (d, J=10.7 Hz), 29.6 (d, J=10.3 Hz), 24.3 (d, J=3.0 Hz), 21.9 (d, J=2.8 Hz), 21.2 (d, J=3.5 Hz), 20.6, 20.4, 19.3.

Compound 30: [α]_{D}²⁵=−19.6° (c=0.52, CHCl₃); ¹H NMR 8.98 (d, 1H, J=33.0 Hz), 7.93 (t, 2H, J=7.5 Hz), 7.16 (t, 2H, J=9.0 Hz), 3.50-3.30 (m, 2H), 3.09 (t, 2H, J=12.0 Hz), 2.84 (t, 2H, J=12.0 Hz), 2.15-2.04 (m, 2H), 1.90-1.75 (m, 2H), 1.45-1.30 (m, 3H), 1.30-1.22 (m, 10H), 1.11 (d, 3H, J=5.0 Hz); ¹³C NMR 169.9 (d, J=7.3 Hz), 165.6 (d, J_{CF}⁼253.2 Hz), 132.6 (d, J=28.1 Hz), 132.18, 132.11, 116.0, 115.91, 59.7 (d, J=7.8 Hz), 59.3 (d, J=8.8 Hz), 45.1 (d, J=3.0 Hz), 44.5 (d, J=3.0 Hz), 29.6 (d, J=9.8 Hz), 29.4 (d, J=9.3 Hz), 24.3, 24.2, 21.8 (d, J=3.0 Hz), 20.9 (d, J=3.5 Hz), 20.6, 20.4.

Compound 31: ¹H NMR 8.96 (d, 1H, J=33.0 Hz), 7.86 (d, 2H, J=8.5 Hz), 7.46 (d, 2H, J=8.5 Hz), 3.50-3.30 (m, 2H), 3.09 (t, 1H, J=12.0 Hz), 2.83 (t, 1H, J=12.0 Hz), 2.15-2.02 (m, 2H), 1.90-1.75 (m, 2H), 1.45-1.30 (m, 13H), 1.30-1.20 (m, 10H), 1.10 (d, 3H, J=6.5 Hz); ¹³C NMR 169.9 (d, J=6.8 Hz), 139.0, 134.6 (d, J=28.1 Hz), 131.1 (2C), 129.1 (2C), 59.8 (d, J=8.3 Hz), 59.3 (d, J=8.8 Hz), 45.1 (d, J=2.8 Hz), 44.5 (d, J=2.8 Hz), 29.6 (d, J=9.8 Hz), 29.5 (d, J=9.3 Hz), 24.3 (d, J=4.5 Hz), 21.8 (d, J=3.3 Hz), 20.9 (d, J=2.8 Hz), 20.6, 20.4.

Compound 32: [α]_{D}²⁵37.5° (c=0.90, CHCl₃); NMR 9.40 (d, 1H, J=32.5 Hz), 8.18 (d, 1H, J=7.0 Hz), 7.48-7.40 (m, 2H), 7.38-7.32 (m, 1H), 3.58-3.40 (m, 2H), 3.08 (t, 1H, J=12.0 Hz), 2.66 (m, 1H), 2.16-2.00 (m, 2H), 1.88-1.74 (m, 2H), 1.45-1.20 (m, 13H), 1.10 (d, 3H, J=6.5 Hz); ¹³C NMR 165.9 (d, J=5.8 Hz), 137.6, 133.3, 132.8 (d, J=27.6 Hz), 129.9 (d, J=1.5 Hz), 129.1, 127.0, 59.7 (d, J=7.8 Hz), 58.9 (d, J=9.8 Hz), 45.1 (d, J=2.5 Hz), 44.6 (d, J=3.0 Hz), 29.8 (d, J=9.3 Hz), 29.4 (d, J=10.3 Hz), 24.2, 21.8 (d, J=2.8 Hz), 21.4 (d, J=4.0 Hz), 20.57, 20.56, 20.55.

Compound 33: [α]_{D}²⁵2.3° (c=0.42, CHCl₃); ¹H NMR 8.96 (d, 1H, J=32.5 Hz), 7.78 (d, 2H, J=8.5 Hz), 7.62 (d, 2H, J=8.5 Hz), 3.58-3.30 (m, 2H), 3.08 (t, 1H, J=12.0 Hz), 2.82 (t, 1H, J=12.0 Hz), 2.14-2.00 (m, 2H), 1.90-1.78 (m, 2H), 1.40-1.30 (m, 3H), 1.30-1.20 (m, 10H), 1.10 (d, 3H, J=6.5 Hz); ¹³C NMR 169.9 (d, J=7.0 Hz), 135.1 (d, J=28.2 Hz), 132.1 (2C), 131.2 (2C), 59.8 (d, J=8.0 Hz), 59.3 (d, J=8.0 Hz), 45.1 (d, J=2.4 Hz), 44.5 (d, J=2.9 Hz), 29.6 (d, J=9.9 Hz), 29.4 (d, J=9.4 Hz), 24.2 (d, J=3.5 Hz), 21.8 (d, J=3.4 Hz), 20.9 (d, J=3.0 Hz), 20.6 (d, J=1.0 Hz), 20.4 (d, J=1.5 Hz).

Compound 34: [α]_{D}²⁵=−18.7° (c=0.73, CHCl₃); NMR 9.28 (d, 1H, J=32.5 Hz), 8.16 (d, 1H, J=7.5 Hz), 7.63 (d, 1H, J=7.5 Hz), 7.42-7.32 (m, 2H), 3.60-3.40 (m, 2H), 3.07 (t, 1H, J=11.5 Hz), 2.62 (t, 1H, J=11.5 Hz), 2.18-2.00 (m, 2H), 1.90-1.78 (m, 2H), 1.50-1.15 (m, 13H), 1.09 (d, 3H, J=6.5 Hz); ¹³C NMR 168.1 (d, J=5.8 Hz), 134.3 (d, J=27.6 Hz), 133.5, 133.3, 133.2, 129.6, 127.7, 127.6, 59.8 (d, J=7.8 Hz), 58.8 (d, J=10.3 Hz), 45.2 (d, J=3.0 Hz), 44.6 (d, J=2.5 Hz), 29.9 (d, J=9.3 Hz), 29.4 (d, J=9.8 Hz), 24.2, 21.9 (d, J=3.0 Hz), 21.5 (d, J=4.0 Hz), 20.62, 20.60.

Compound 35: [α]_{D}²⁵−3.5° (c=0.62, CHCl₃); ¹H NMR 8.99 (d, 1H, J=32.0 Hz), 8.02 (d, 2H, J=8.0 Hz), 7.78 (d, 2H, J=8.0 Hz), 3.52-3.36 (m, 2H), 3.09 (t, 1H, J=12.0 Hz), 2.82 (t, 1H, J=12.0 Hz), 2.16-2.00 (m, 2H), 1.90-1.74 (m, 2H), 1.45-1.32 (m, 3H), 1.32-1.18 (m, 10H), 1.10 (d, 3H, J=6.5 Hz); ¹³C NMR 168.6 (d, J=7.0 Hz), 139.6 (d, J=27.6 Hz), 132.4 (2C), 130.0 (2C), 118.1, 115.6, 59.6 (d, J=8.0 Hz), 59.3 (d, J=8.8 Hz), 45.1 (d, J=2.5 Hz), 44.5 (d, J=3.5 Hz), 29.5 (d, J=5.8 Hz), 29.4 (d, J=5.5 Hz), 24.2, 21.8 (d, J=2.8 Hz), 21.0 (d, J=2.8 Hz), 20.6, 20.5.

Similar synthesis provided derivatives of 35 (formula (IV), 36-38):

Compound 36: ¹H NMR 0.81-1.05 (m, 4H), 1.10-1.92 (m, 10H), 1.98-2.30 (m, 4H), 2.62-2.97 (m, 3H), 3.09 (d, 2H, J=6.6 Hz), 7.28-7.53 (m, 3H), 7.89 (d, 2H, J=8.1 Hz), 9.09 (d, 1H, ³J_{PH}=32.4H).

Compound 37: ¹H NMR 1.19-2.17 (m, 24H), 2.72-2.81 (m, 1H), 2.98-3.08 (m, 1H), 3.39-3.55 (m, 2H), 7.41-7.53 (m, 3H), 7.92 (d, 2H, J=8.4 Hz), 9.02 (d, 1H, ³J_{PH}=33.3 Hz).

Compound 38: ¹H NMR 0.92-2.07 (m, 25H), 2.89-3.10 (m, 7H), 7.41-7.58 (m, 3H), 7.93 (d, 2H, J=6.9 Hz), 9.06 (d, 1H, ³J_{PH}=33.0 Hz).

TABLE 1
Shows results of chiral N— Bn-N-phosphonyl imine synthesis

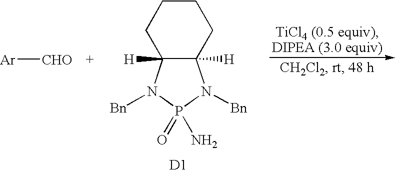

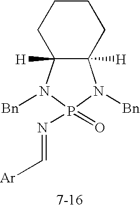

| Entry | Ar | Product | % Yield |
|---|---|---|---|
| 1. | Phenyl | 7 | 65 |
| 2. | 4-MeO-phenyl | 8 | 66 |
| 3. | 4-BnO-phenyl | 9 | 65 |
| 4. | 4-Me-phenyl | 10 | 68 |
| 5. | 2-Me-phenyl | 11 | 64 |
| 6. | 4-F-phcnyl | 12 | 74 |
| 7. | 4-Cl-phenyl | 13 | 69 |
| 8. | 2-Cl-phenyl | 14 | 66 |
| 9. | 4-Br-phenyl | 15 | 67 |
| 10. | 2-Thienyl | 16 | 63 |

TABLE 2
Shows results of synthesis of chiral N-1-Naphth N-phosphonyl imines

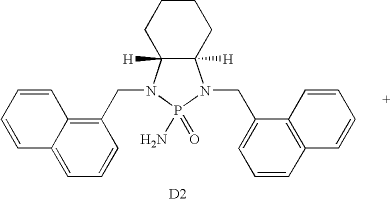

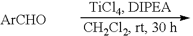

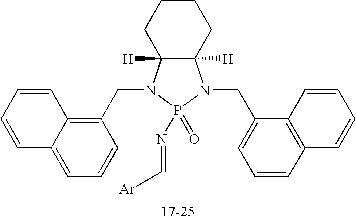

| entry | Ar | product | yield (%) |
|---|---|---|---|
| 1 | Ph | 17 | 76 |
| 2 | 2-MeO-Ph | 18 | 80 |
| 3 | 4-Me-Ph | 19 | 81 |
| 4 | 2-F-Ph | 20 | 77 |
| 5 | 2-Br-Ph | 21 | 70 |
| 6 | 2-Cl-Ph | 22 | 72 |
| 7 | 2-Me-Ph | 23 | 83 |
| 8 | 2,6-Dimethyl-Ph | 24 | 61 |
| 9 | Naphthyl | 25 | 68 |

TABLE 3
Shows synthesis of chiral N-i-Pr-phosphonyl imines.

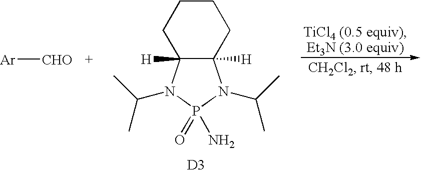

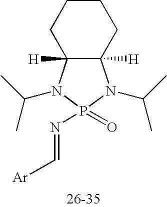

| Entry | Ar | Product | % Yield |
|---|---|---|---|
| 1. | Phenyl | 26 | 74 |
| 2. | 4-MeO-phenyl | 27 | 65 |
| 3. | 4-Me-phenyl | 28 | 66 |
| 4. | 2-Me-phenyl | 29 | 68 |
| 5. | 4-F-phenyl | 30 | 68 |
| 6. | 4-Cl-phenyl | 31 | 69 |
| 7. | 2-Cl-phenyl | 32 | 65 |
| 8. | 4-Br-phenyl | 33 | 71 |
| 9. | 2-Br-phenyl | 34 | 62 |
| 10. | 4-CN-phenyl | 35 | 66 |

1. Free NH2-group-attached chiral phosphoramides, having the structure of formula (I): 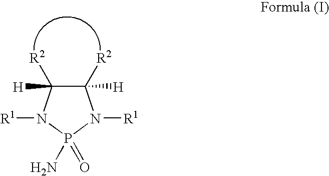
wherein R1 and R2 are independently any organic groups.

2. The free NH2-group-attached chiral phosphoramides of claim 1, wherein R1 is a C1-C20 alkyls, such as i-Pr, Me, Et, Pr, 2-Bu; Aryl; CH2-Aryl (e.g., Aryl=Ph, 1-Naph, 2-Naph, etc.); and Ts, Bs, Ms and C1-C20-, Ar—SO2-; R2 is an Aryl, Alkyl; two alkyl R2 groups can be connected as cycloalkanes, i.e., diamine precursors can be 1,2-diaminocyclohexane and 1,2-diaminocyclopentane.

3. The free NH2-group-attached chiral phosphoramides of claim 1, wherein the compounds of formula (I) can be racemic compounds or each of the two individual enantiomers, or combination thereof.

4. The free NH2-group-attached chiral phosphoramides of claim 1, having one of the structures of formula (II):

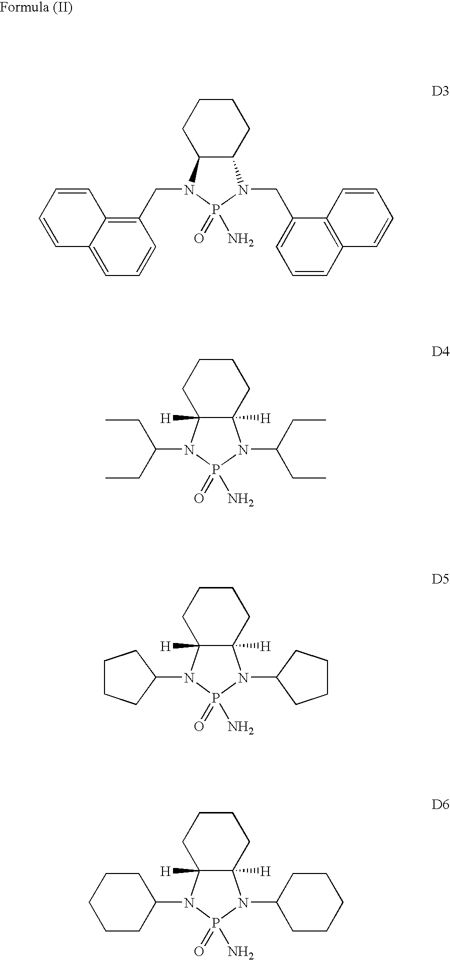

5. Chiral N-phosphonimines, having the structure of formula (III) 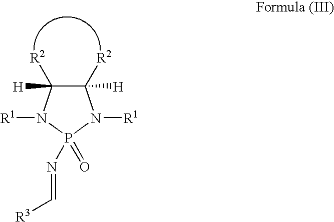
wherein R1, R2 and R3 are independently any organic groups.

6. The chiral N-phosphonimines of claim 5, wherein R1 is a C1-C20 alkyls, such as i-Pr, Me, Et, Pr, 2-Bu; Aryl; CH2-Aryl (e.g., Aryl=Ph, 1-Naph, 2-Naph, etc.); and Ts, Bs, Ms and C1-C20-R—SO2-, Ar—SO2-; R2 is an Aryl, Alkyl in which two alkyl R2 groups can be connected as cycloalkanes, i.e., diamine precursors can be 1,2-diaminocyclohexane and 1,2-diaminocyclopentane; R3 is an Aryl, Alkyl group.

7. The chiral N-phosphonimines of claim 5, having one of the structures of formula (IV):

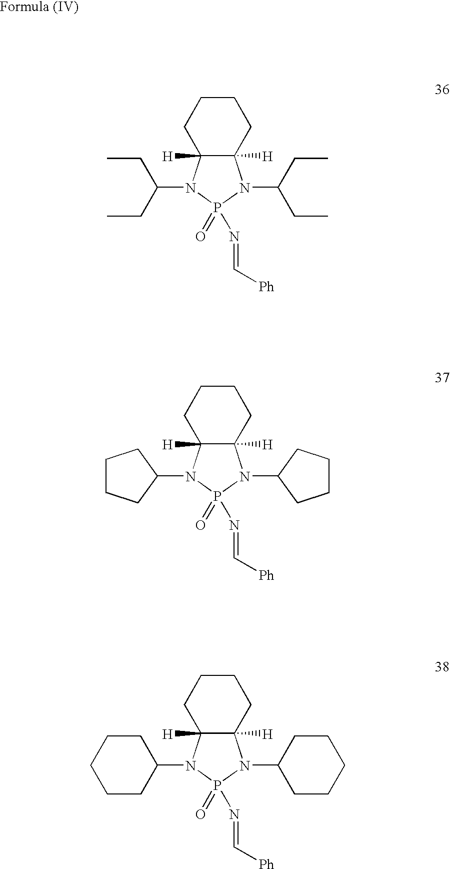

8. A method of forming the free NH2-group-attached chiral phosphoramides of claim 1, comprising: a) providing phosphoramides, and 2) synthesizing chiral N-phosphonimines from free NH2-group-attached chiral phosphoramides.

9. The method of claim 8, comprise the steps of:
A. Synthesis of N,N′-di-primary alkyl-1,2-diaminocyclohexane;
B. Synthesis of N,N′-di secondary alkyl-1,2-diaminocyclohexane.

10. The method of claim 8, wherein the free NH2-group-attached chiral phosphoramide is accordingly to claim 1.

11. The method of claim 8, wherein comprise the reaction for synthesis of N,N′-di-primary alkyl-N-phosphoramides of formula (V):

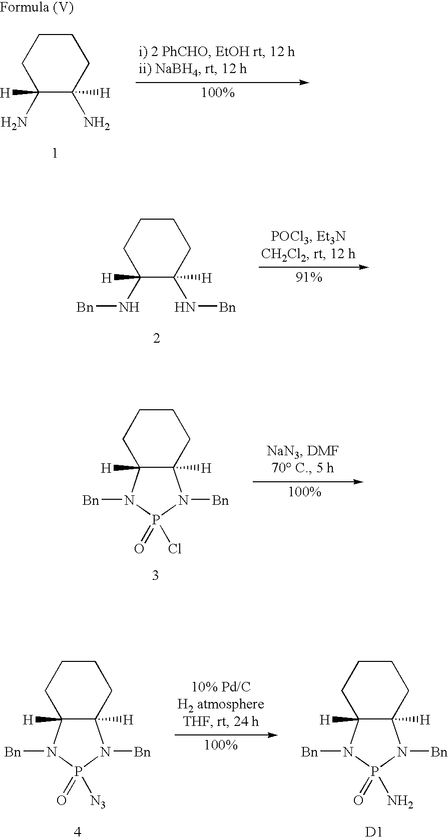

12. The method of claim 8, wherein comprise the reaction for synthesis of N,N′-di-secondary alkyl-N-phosphoramides of formula (VI):

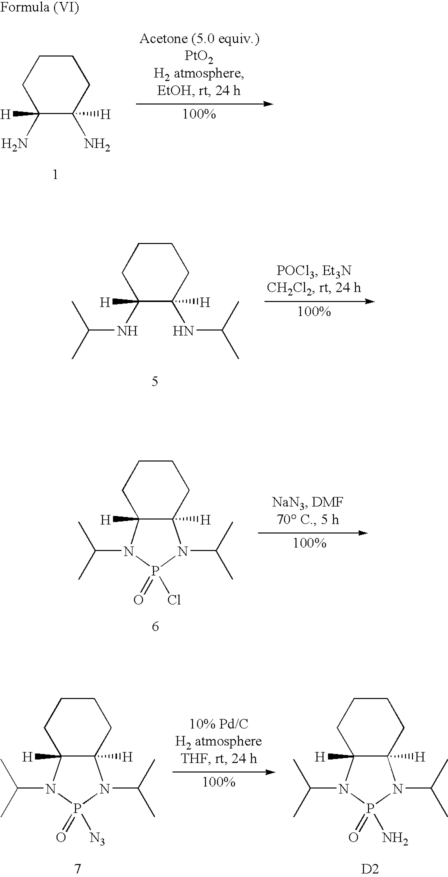

13. The use of the free NH2-group-attached chiral phosphoramides of claim 1 in preparing of chiral N-phosphonimines.

14. A method of forming the chiral N-phosphonyl imines of claim 5, comprise the steps of:
A. Synthesis of N,N′-di-primary alkyl-N-phosphonyl imines;
B. Synthesis of N,N′-di-secondary alkyl-N-phosphonyl imines.

15. A method of claim 14, comprise the reaction for synthesis of synthesis of chiral N-phosphonyl imines of formula (VII): [chemical structure]
